(19) United States
(12) Patent Application Publication
(10) Pub. No.: US 2005/0138672 A1
(43) Pub. Date: Jun. 23, 2005

(54) Digital video recorder recognizing end of program metadata incorporated in a transport packet stream

(76) Inventor: Christopher J. Stone, Newtown, PA (US)

Correspondence Address: MAYER, FORTKORT & WILLIAMS, PC, 251 NORTH AVENUE WEST, 2ND FLOOR, WESTFIELD, NJ, 07090, US

(21) Appl. No.: 10/743,194

(22) Filed: Dec. 22, 2003

(51) Int. Cl. H04N 7/16; H04N 7/173

(52) U.S. Cl. 725/134; 725/142; 725/89

(57) ABSTRACT

A method and apparatus is provided for recording a broadcast program. The method begins by receiving a transport packet stream (200) in which the program is embodied. The transport packet stream (200) includes an indicator denoting a time at which the program ends. The transport packet is electronically stored and the indicator from the transport packet stream is extracted. The extracted indicator is decoded and the step of electronically storing the transport packet stream (200) is terminated in accordance with the time denoted by the indicator.

### FIELD OF THE INVENTION

The invention relates generally to digital video recorder systems, and more particularly to a digital video recording system that automatically terminates or extends a recording session based on the actual time a program ends rather than its scheduled end time.

### BACKGROUND OF THE INVENTION

Digital video recorder (DVR) systems are becoming increasingly popular with consumers. Digital video recorder systems use magnetic hard disk drives rather than magnetic cassette tapes to store video programs received from coaxial cable, a satellite dish, an antenna for terrestrial radio frequency signals, or a modem that permits access to content from the Internet. For example, the ReplayTV™ recorder and the TiVO™ recorder record television programs in digital formats on hard disk drives using, for example, MPEG-2 compression. Also, some DVR systems may record on a readable/writable digital versatile disk (DVD) rather than a magnetic disk. Users may schedule programs to be recorded and may play back the recorded programs at a later time. These systems also record what users are watching in real-time, allowing users to pause real-time programs when, for example, the user must leave the room. The systems may continue recording and storing the program being broadcast while the displayed program is paused. Users may resume their viewing where they left off, and may fast forward through commercials until they reach the point at which the program is currently being provided.

Presently, DVR systems can record a broadcast when the user establishes a start and stop recording time. Alternatively, the DVR system may rely on an electronic program guide (EPG), which is an interactive, on-screen display feature that displays information analogous to TV listings found in local newspapers or other print media. An EPG provides information about each program being broadcast within the time period covered by the EPG, which typically ranges from the next hour up to several days. The information contained in an EPG includes programming characteristics such as, for example, channel number, program title, start time, end time, elapsed time, time remaining, and a brief description of the program's content. Unlike non-interactive guides that reside on a dedicated channel and merely scroll through the current programming on the other channels for the next few hours, EPGs allow viewers to select any channel at any time during some period into the future, e.g., up to several days forward. The EPG allows the viewer to automatically record a program based on the information in the EPG.

The EPG data, however, assumes that the program will begin and end at its scheduled time. The EPG data cannot be used to predict the end of program that is either delayed or which does not adhere to a strict timetable (e.g., a sporting event that extends into overtime). Similarly, some broadcasts may end earlier than anticipated (e.g., a scheduled 12 round boxing match that may have ended in the first round), thus needlessly recording and storing unwanted broadcast data.

Accordingly, it would be desirable to provide a method and apparatus for a digital video recorder system that has the ability to automatically terminate or extend a recording session based on the actual time a program has ended.

### SUMMARY OF THE INVENTION

In accordance with the present invention, a method and apparatus is provided for recording a broadcast program. The method begins by receiving a transport packet stream in which the program is embodied. The transport packet stream includes an indicator denoting a time at which the program ends. The transport packet is electronically stored and the indicator from the transport packet stream is extracted. The extracted indicator is decoded and the step of electronically storing the transport packet stream is terminated in accordance with the time denoted by the indicator.

In accordance with one aspect of the invention, the transport packet stream is received in accordance with a digital transport protocol.

In accordance with another aspect of the invention, the digital transport protocol includes video compression.

In accordance with another aspect of the invention, the transport packet stream is an MPEG-2 bit stream.

In accordance with another aspect of the invention, the indicator is located in an MPEG-2 system table.

In accordance with another aspect of the invention, the MPEG-2 system table is a program map table.

In accordance with another aspect of the invention, the indicator is incorporated into the transport packet stream by a universal data format.

In accordance with another aspect of the invention, the universal data format is the XML data format.

In accordance with another aspect of the invention, the electronically storing step is performed on a magnetic storage device.

In accordance with another aspect of the invention, the electronically storing step is performed on an optical storage device.

In accordance with another aspect of the invention, a digital video recorder system is provided. The recorder includes a processor receiving a transport packet stream in which the program is embodied. The transport packet stream includes an indicator denoting a time at which the program ends. An encoder/decoder is provided for encoding and decoding the transport packet stream and converting the decoded packet stream into a signal that is displayable on a display device. The recorder also includes a storage device for electronically storing the encoded transport packet stream. The processor extracts and decodes the indicator from the transport packet stream and terminates a previously initiated session of program recording in accordance with the time denoted by the indicator.

### BRIEF DESCRIPTION OF THE DRAWINGS

FIG. 1 depicts the main components of a DVR system constructed in accordance with the principles of the present invention.

FIG. 2 illustrates a conceptual block diagram an MPEG-2 bit stream.

FIG. 3 shows an exemplary broadcast system that transmits the end of program metadata in accordance with the principles of the present invention.

### DETAILED DESCRIPTION

The present invention allows a digital video recorder (DVR) system to automatically terminate or end a recording session based on metadata that is incorporated with the content of the program that is to be recorded. The metadata, which defines the time at which the program actually ends as opposed to when it may have been scheduled to end, is incorporated into the content itself by the content provider or the service provider that broadcasts the program. The DVR system recognizes the metadata and terminates the recording process in accordance therewith.

The metadata may be incorporated into the content in any format that allows it to be recognized and extracted by the DVR system. In one particular embodiment of the invention, detailed below, the end of program metadata is incorporated into a program map table of an MPEG-2 bit stream. Of course, the present invention is not limited to established broadcast and transport protocols such as the MPEG-2 system, but rather encompasses any other means by which the end of time metadata can be defined and encoded along with the content. For example, the end of time metadata may be incorporated into the content via standards established with the use of a metalanguage used to describe structured information. For example, the metalanguage that is employed may be a universal data format such as XML.

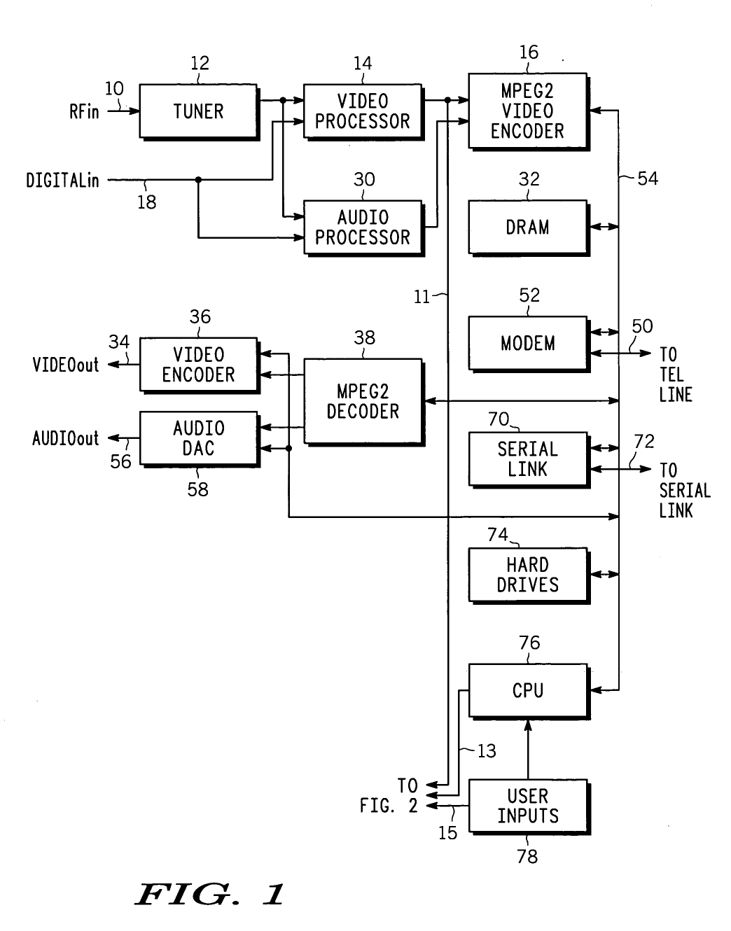

FIG. 1 depicts the main components of a DVR system constructed in accordance with the present invention. The system has two inputs, an RF input 10 and a digital input 18. The RF input is extended to a tuner 12 in a conventional manner in order to select a particular channel. The digital input and the tuner output are both operated upon by a video processor 14 and an audio processor 30. Both processor outputs are compressed in MPEG2 video encoder 16 and stored on the disk(s) of hard drive(s) 74. (Alternatively, the audio and video could be processed and stored independently, e.g., MPEG 2 video compression for the video and Dolby Digital audio compression for the audio, so long as the audio and video are synchronized for play.)

Communications, both data and control, take place over system bus 54 under control of CPU 76 and its operating system. The system includes conventional components such as DRAM memory 32, a modem 52 for communicating over a telephone line, for example, to a server that furnishes TV schedule information, a serial link module 70 for communicating with other devices, and user inputs 78 which may include a keyboard and a remote control device. Under control of the operating system, stored program data is read from the hard disks, decoded in MPEG2 decoder 38, and extended through video encoder 36 to the video out line 34, and through audio digital-to-analog converter 58 to the audio out line 56. Not shown in the drawing are features that are not necessary for an understanding of the present invention, such as the different kinds of output connections that are provided (e.g., S-Video), infra-red links, a boot ROM, etc.

As previously mentioned, the end of program metadata may be transmitted to the DVR system using a protocol such MPEG-2 Systems, which is a digital transport protocol that specifies how digital information is to be broadcast. This protocol defines packet configuration, synchronization, multiplexing and stream identification. Packets are filled with audio, video, or data according to specifications set forth by the Advanced Television Systems Committee (ATSC). Video, for example, is compressed and encoded using MPEG-2 technologies. Similarly, audio is compressed and encoded using AC-3 technologies.

The MPEG-2 system layer facilitates (i) multiplexing one or more programs made up of related audio and video bit streams into a single bit stream for transmission through a transmission medium, and (ii) de-multiplexing of the single bit stream into separate audio and video program bit streams for decompression while maintaining synchronization. The system layer defines data stream syntax for timing control and synchronization and interleaving of the video and audio bit streams. The system layer is capable of: i) video and audio synchronization, ii) stream multiplexing, iii) packet and stream identification, iv) error detection, v) buffer management, vi) random access and program insertion, vii) private data, viii) conditional access, and ix) interoperability with other networks, such as those using asynchronous transfer mode (ATM). The MPEG-2 compression layer comprises the coded video and audio data streams. The system layer provides control data for multiplexing and de-multiplexing interleaved compression layers and, in doing so, defines those functions necessary for combining the compressed data streams.

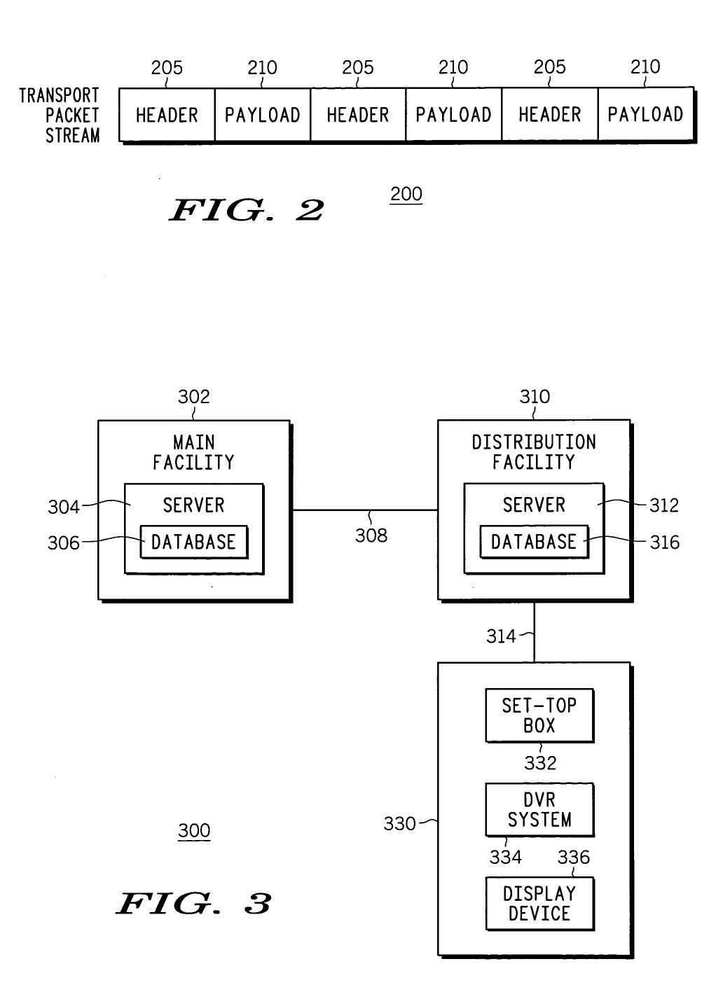

FIG. 2 illustrates a conceptual block diagram an MPEG-2 bit stream 200, which comprises a transport packet stream, wherein each packet illustratively comprises packet header 205 and payload 210 (i.e., packet data bytes). An MPEG-2 bit stream comprises two layers, namely, a system layer (also referred to as an outer layer, a control layer, or the like) and a compression layer (also referred to as an inner layer, a payload layer, a data layer, or the like).

The packets in the MPEG-2 transport packet stream may be classified into three types: program elementary stream (PES) packets, program specific information (PSI) packets, and privately defined packets. PES packets are typically used to carry audiovidual information, whereas PSI packets are used to carry, among other things, so-called PSI data, which includes MPEG-2 System Tables such as the program association table (PAT) and the program map table (PMT). PAT describes the number of programs in a transport packet stream and determines how to the find the associated PMP for each program. Consequently, each transport stream contains one PAT and several PMTs (one for each program). THE PMT describes the elementary streams that compose an individual program. An elementary stream is a collection of packets that can be recognized by their Packet Identifier (PID) value. The PID is the most important field in the header of transport stream packet. Each entry in the PMT is related to one program. The PMT provides a mapping between packets and programs, and contains a program number that identifies the program within the stream, a descriptor to carry private information about the program, the identification of the packets that contain the synchronization information, a number of pairs of values (e.g., stream type (ST), Data-PID) which, for each stream, specify the ST and the PID of the packets containing the data of that stream or program (Data-PID).

Collectively, the MPEG-2 System Tables are used to process a particular program. At any point in time, each program has a unique packet identifier (PID) in the PMT, which provides the PIDs for the selected program's audio, video, and control streams. The streams with the selected PIDs are extracted and delivered to the appropriate buffers and decoders for reconstruction and decoding.

In accordance with one embodiment of the present invention, the end of program metadata may be incorporated by the content provider or distributor directly into the MPEG-2 transport packet stream. In particular, the end of program metadata may be conveniently located as an entry in one of the MPEG-2 system tables such as the PMT. When the transport packet stream is received by DVR system, the metadata can be processed by video processor 14 in FIG. 1, decoded by MPEG-2 decoder 38 are forwarded to the CPU 76. The CPU 76, in turn, can terminate program recording at the time dictated by the end of program metadata.

As previously mentioned, in other embodiments of the invention the end of program metadata may be incorporated into the transport stream by various metalanguages. In these embodiments the end of program data can be processed, extracted and used by the CPU 76 to terminate the recording process in a manner similar to that described above.

An illustrative broadcast system that transmits the end of program metadata in accordance with the principles of the present invention is shown in FIG. 3. Broadcast system 300 may include main facility 302, distribution facility 310, and user equipment 330. While the broadcast system 300 may include multiple main facilities 302, only one main facility 302, however, is illustrated in FIG. 3 for the purpose of clarity.

Main facility 302 may be operated by a content provider and includes server 304 for storing and distributing programs from program database 306. Main facility 302 may distribute the programs to distribution facility 310 via communications path 308. Main facility 302 may also insert into the programming the end of program metadata in accordance with the present invention. Alternatively, the metadata may be inserted at the distribution facility 310, discussed below.

Communications path 308 may be any suitable communications path, such as a satellite link, a cable link, a fiber-optic link, a microwave link, a telephone network link, an Internet link, or a combination thereof. For simplicity only one distribution facility 310 is shown in FIG. 3. Of course, multiple distribution facilities may be involved in implementing interactive services.

Distribution facility 310 may be a television distribution facility for broadcast television, a cable system headend, a satellite distribution facility, or any other suitable distribution facility for distributing transport packet streams to viewers. Distribution facility 310 may distribute program guide information, programming content, end of program metadata, or any other suitable content or information to user equipment 330 via communications paths 314. Distribution facility 310 may include server 312 for storing such content and information. Server 312 may be used for distributing television programming, music, or any other suitable type of media in response, for example, to requests for such content and information. Server 312 may include a local database 316 for storing various information and content. In addition, server 312 may be capable of providing other interactive services such as video-on-demand.

Communications path 314 may be any suitable type of link that allows distribution facility 310 to distribute programming to user equipment 330. There may be more than one communications path 314 that couples the user equipment 330 to distribution facility 310. For example, if distribution facility 310 is a cable headend, user equipment 330 may receive information via a cable link and may transmit information to distribution facility 310 via a digital serial link, a dial-up modem connection, or any other suitable link. Each of communication paths 314 may be unidirectional or bi-directional.

User equipment 330 may be based on a television platform, a computer platform, or both. For example, user equipment 330 may include user television equipment (e.g., a television set, a DVR system, and a set-top box), user computer equipment (e.g., a personal computer), or any other suitable user equipment for receiving, storing and displaying programming. User equipment 330 extracts and decodes the end of program metadata that has been incorporated in the programming by the main facility 302 or distribution facility 310. User equipment 330 terminates the storage or recording process in accordance with the end of program metadata. User computer equipment may include a computer based receiver having integrated set-top box circuitry or a personal computer television (PC/TV).

In the particular embodiment depicted in FIG. 3, user equipment 330 is user television equipment that is based on a set-top box arrangement. User television equipment 300 may include set-top box 332, recording device 334, and display device 336. As shown, the set-top box 332 is coupled to recording device 334 and the recording device 334 is coupled to display device 336. These couplings may be based on wired connections, wireless connections, or any suitable network connection. Persons skilled in the art will appreciate that set-top box 332, recording device 334, and display device 336 may be interconnected differently than that shown in FIG. 3 and that components may be added or removed. For example, recording device 334 may be integrated with set-top box 332 in a single device.

Set-top box 332 may receive signals transmitted by distribution facility 310. Set-top box 332 may include a storage device (e. g., a hard drive) or memory for storing personal user preferences settings, user-programmed reminders, or other information. In this embodiment of the invention the set-top box 332 serves as the receiver or tuner. If desired, user television equipment 330 may include multiple tuners which may be used for simultaneously watching one program and recording another.

Set-top box 332 may be coupled to a recording device 334 such as the DVR system shown in FIG. 1. If the user desires to record a program, set-top box 332 may be manually or automatically tuned to a particular channel and control signals may be sent to recording device 334 to record that program. Recording device 334 extracts and decodes the end of program metadata and terminates the storage or recording process in accordance therewith. Set-top box 332 may send audio/video signals and signals that are representative of graphics to display device 336 for presentation to the user. If desired, set-top box 332 may route signals to display device 336 through recording device 334. Display device 336 may be a television, a computer monitor, a computer system with a monitor and speakers, a flat panel display, or any other suitable display device.

It should be noted that the scope of the present invention is not limited by the exemplary DVR system depicted in FIG. 1. For example, the present invention is not limited to a hard drive as depicted in FIG. 1, but may employ in addition to or instead of a hard drive any of the following examples: an optical storage device, a magnetic storage device, an electrical storage device, a network or combinations thereof. Moreover, while the various components have been depicted in FIG. 1 as discrete elements, those of ordinary skill in the art will recognize that the functionality of those elements may be embodied in hardware, software, or any combination thereof, and thus are not necessarily embodied in discrete physical components.

1. A method for recording a broadcast program, said method comprising the steps of:
receiving a transport packet stream in which the program is embodied, said transport packet stream including an indicator denoting a time at which said program ends;
electronically storing said transport packet stream;
extracting said indicator from the transport packet stream;
decoding said extracted indicator; and
terminating the step of electronically storing said transport packet stream in accordance with the time denoted by said indicator.

2. The method of claim 1 wherein said transport packet stream is received in accordance with a digital transport protocol.

3. The method of claim 2 wherein said digital transport protocol includes video compression.

4. The method of claim 1 wherein said transport packet stream is an MPEG-2 bit stream.

5. The method of claim 4 wherein said indicator is located in an MPEG-2 system table.

6. The method of claim 5 wherein said MPEG-2 system table is a program map table.

7. The method of claim 1 wherein said indicator is incorporated into said transport packet stream by a universal data format.

8. The method of claim 7 wherein said universal data format is the XML data format.

9. The method of claim 1 wherein the electronically storing step is performed on a magnetic storage device.

10. The method of claim 1 wherein the electronically storing step is performed on an optical storage device.

11. A digital video recorder system, comprising:
a processor receiving a transport packet stream in which the program is embodied, said transport packet stream including an indicator denoting a time at which said program ends;
an encoder/decoder for encoding and decoding the transport packet stream and converting said decoded packet stream into a signal displayable on a display device;
a storage device for electronically storing said encoded transport packet stream; and
wherein said processor extracts and decodes said indicator from the transport packet stream and terminates a previously initiated session of program recording in accordance with the time denoted by said indicator.

12. The digital video recorder system of claim 11 wherein said transport packet stream is received in accordance with a digital transport protocol.

13. The digital video recorder system of claim 12 wherein said digital transport protocol includes video compression.

14. The digital video recorder system of claim 11 wherein said transport packet stream is an MPEG-2 bit stream.

15. The digital video recorder system of claim 14 wherein said indicator is located in an MPEG-2 system table.

16. The digital video recorder system of claim 15 wherein said MPEG-2 system table is a program map table.

17. The digital video recorder system of claim 11 wherein said indicator is incorporated into said transport packet stream by a universal data format.

18. The digital video recorder system of claim 17 wherein said universal data format is the XML data format.

19. The digital video recorder system of claim 11 wherein the storage device is a magnetic storage device.

20. The digital video recorder system of claim 11 wherein the storage device is an optical storage device.

21. A method for transmitting a broadcast program, said method comprising the steps of:
providing a transport packet stream in which the program is embodied;
incorporating into said transport packet stream an indicator denoting a time at which said program ends; and
transmitting said transport packet stream in which said indicator is incorporated to a digital video recorder system for storage therein.
